(19) United States
(12) Patent Application Publication
(10) Pub. No.: US 2017/0351371 A1
(43) Pub. Date: Dec. 7, 2017

(54) TOUCH INTERACTION BASED SEARCH METHOD AND APPARATUS

(71) Applicant: BEIJING QIHOO TECHNOLOGY COMPANY LIMITED, Beijing (CN)

(72) Inventors: Junyang XIE, Beijing (CN); Qianqian ZHANG, Beijing (CN); Shuai WU, Beijing (CN); Xiangzhen ZHENG, Beijing (CN); Ling LING, Beijing (CN); Xianjin YAN, Beijing (CN)

(21) Appl. No.: 15/539,943

(22) PCT Filed: Nov. 9, 2015
(86) PCT No.: PCT/CN2015/094151

§ 371 Date: Jun. 26, 2017

(30) Foreign Application Priority Data
Dec. 26, 2014 (CN) 201410834136.2

(51) Int. Cl. G06F 3/041; G06F 3/0488; G06F 3/0484; G06F 17/30

(52) U.S. Cl. CPC G06F 3/0416; G06F 17/30864; G06F 3/04886; G06F 3/0484; G06F 3/04842; G06F 3/04883

(57) ABSTRACT

The invention discloses a touch interaction based search method and apparatus, comprising: receiving a trigger instruction from a user for conducting search based on a current interface; receiving a touch slide operation performed by the user on the current interface, and determining a slide area according to the touch slide operation; and based on the slide area, extracting an object therein and conducting search with respect to the object. Employment of the invention can solve the problem of slow and inconvenient search via a keyboard (including a soft keyboard), save operations such as opening a search box, copy & paste, etc., make the search operation simple and easy, solve the problem of search if one wants on a touch interaction based terminal, save time and improve user's experience.

### FIELD OF THE INVENTION

The invention relates to the field of internet search, and in particular, to a touch interaction based search method and apparatus.

### BACKGROUND OF THE INVENTION

With the development trend of internet business, mobile terminals more and more become the main carrier of internet business due to their mobility and convenience. People increasingly tend to look for information, browse the internet, play game and entertainment and the like on mobile terminals carried with them.

Search services on a mobile terminal (e.g., a smart phone), such as various search apps, are all based on an input in a search box. In use, it is necessary to open a search app, enter a search word in a search box, click to confirm, and then trigger a search operation.

However, in view of that a touch screen requires a user to input via touch, and a problem of input being inconvenient occurs to the search box due to its narrowness and smallness, this lead to poor search experience and a low efficiency. Especially when a user has various real-time search needs based on a character, an image, etc. on the screen at the time of using a smart phone, he has to open a search app, and then enter in a popup search box, which is very inconvenient.

### SUMMARY OF THE INVENTION

In view of the above problems, the invention is proposed to provide a touch interaction based search method and a corresponding apparatus, which overcome the above problem or at least in part solve or mitigate the above problem.

According to an aspect of the invention, there is provided a touch interaction based search method comprising:

receiving a trigger instruction from a user for conducting search based on a current interface;

receiving a touch slide operation performed by the user on the current interface, and determining a slide area according to the touch slide operation; and

based on the slide area, extracting an object therein and conducting search with respect to the object.

According to another aspect of the invention, there is provided a touch interaction based search apparatus comprising:

a reception module configured to receive a trigger instruction from a user for conducting touch search based on a current interface;

the reception module further configured to receive a touch slide operation performed by the user on the current interface;

an area determination module configured to determine a slide area according to the slide operation;

an objection recognition module configured to, based on the slide area, extract an object therein; and

a search module configured to conduct search with respect to the object.

According to yet another aspect of the invention, there is provided a computer program comprising a computer readable code which causes a computing device to perform the touch interaction based search method described above, when said computer readable code is running on the computing device.

According to still another aspect of the invention, there is provided a computer readable medium storing therein a computer program as described above.

The beneficial effects of the invention lie in that:

In embodiments of the invention, a user sends out a trigger instruction for search based on a current interface; afterwards, a slide area is determined according to a touch slide operation performed by the user on the current interface; and then, based on the slide area, an object therein is extracted, and search is conducted with respect to the extracted object. From the above, the search of the embodiments of the invention does not need to open a search app, input an object in a search box, or copy & paste a selected object into a search box, and then conduct search. Rather, the embodiments of the invention define a slide area through a user's touch slide operation, directly extract an object in the slide area and search for it, which solves the problem of slow and inconvenient search due to inputting via a keyboard (including a soft keyboard), saves the above mentioned operations such as opening a search box, copy & paste, etc., makes the search operation simple and easy, solves the problem of search if one wants on a touch interaction based terminal, saves time and improves user's experience. In addition, the slide area can adequately reflect the user's search intention, which solves the drawback that a part of the existing search apps can only copy the whole content, but can not accurately search for a single word or several discrete words, and improves the accuracy of searching for a word.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows schematically a processing flow chart of a touch interaction based search method according to an embodiment of the invention;

FIG. 2 shows schematically a schematic diagram of an SMS interface according to an embodiment of the invention;

FIG. 3 shows schematically a schematic diagram of adding an operable layer on the interface of FIG. 2 according to an embodiment of the invention;

FIG. 4 shows schematically a schematic diagram of a query result of searching for an express delivery number according to an embodiment of the invention;

FIG. 5 shows schematically a schematic diagram of an IM chat record according to an embodiment of the invention;

FIG. 6 shows schematically a schematic diagram after adding an operable layer on the interface shown in FIG. 5 according to an embodiment of the invention;

FIG. 7 shows schematically a schematic diagram of the address of “360 corporate headquarters” according to an embodiment of the invention;

FIG. 8 shows schematically a structure diagram of a touch interaction based search apparatus according to an embodiment of the invention;

FIG. 9 shows schematically another structure diagram of a touch interaction based search apparatus according to an embodiment of the invention;

FIG. 10 shows schematically a block diagram of a computing device for performing a touch interaction based search method according to the invention; and

FIG. 11 shows schematically a storage unit for retaining or carrying a program code implementing a touch interaction based search method according to the invention.

### DETAILED DESCRIPTION OF THE INVENTION

In the following the invention will be further described in conjunction with the drawings and the particular embodiments. While the exemplary embodiments of the disclosure are shown in the drawings, it will be appreciated that the disclosure may be implemented in various forms and should not be limited by the embodiments set forth herein. Rather, these embodiments are provided in order for one to be able to more thoroughly understand the disclosure and in order to be able to fully convey the scope of the disclosure to those skilled in the art.

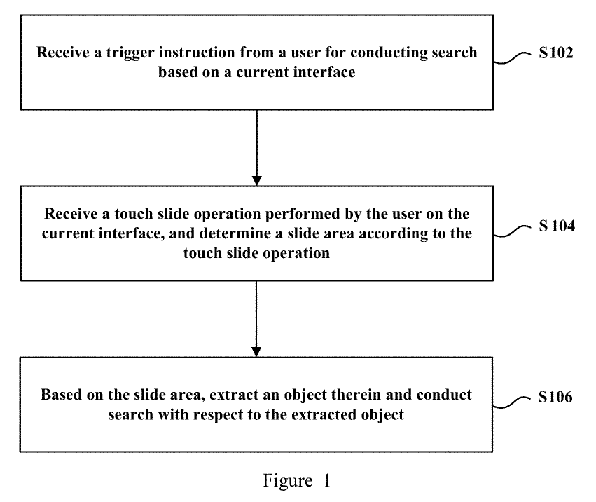

To solve the above technical problem, an embodiment of the invention provides a touch interaction based search method. FIG. 1 shows schematically a processing flow chart of a touch interaction based search method according to an embodiment of the invention. With reference to FIG. 1, the method comprises at least step S102 to step S106:

step S102, receiving a trigger instruction from a user for conducting search based on a current interface;

step S104, receiving a touch slide operation performed by the user on the current interface, and determining a slide area according to the touch slide operation; and

step S106, based on the slide area, extracting an object therein and conducting search with respect to the extracted object.

The embodiment of the invention implements a touch interaction based search method. In the embodiment of the invention, a user sends out a trigger instruction for search based on a current interface; afterwards, a slide area is determined according to a touch slide operation performed by the user on the current interface; and then, based on the slide area, an object therein is extracted, and search is conducted with respect to the extracted object. From the above, the search of the embodiment of the invention does not need to open a search app, input an object in a search box, or copy & paste a selected object into a search box, and then conduct search. Rather, the embodiment of the invention defines a slide area through a user's touch slide operation, directly extracts an object in the slide area and searches for it, which solves the problem of slow and inconvenient search due to inputting via a keyboard (including a soft keyboard), saves the above mentioned operations such as opening a search box, copy & paste, etc., makes the search operation simple and easy, solves the problem of search if one wants on a touch interaction based terminal, saves time and improves user's experience. In addition, the slide area can adequately reflect the user's search intention, which solves the drawback that a part of the existing search apps can only copy the whole content, but can not accurately search for a single word or several discrete words, and improves the accuracy of searching for a word.

The touch interaction based search method provided by the embodiment of the invention applies to any terminal which provides a touch interaction mode, especially a currently common mobile terminal which provides a touch screen. By using a finger or a touch pen to perform an operation on the touch screen, a user can define a slide area visibly and intentionally, which better reflects the user's search intention. In particular, after capturing the slide area, a corresponding screenshot of the slide area may be obtained. The screenshot can faithfully reflect the content of the slide area, avoid that an error occurs to data or an element or an object, or the like, as compared to the actual situation, and increase the authenticity and integrity of the data. The screenshot may be for a certain webpage, for a picture of a certain animation, for a frame of image of a video, for an application interface of a certain app, for a desktop of a terminal, or a picture or photo in a user's picture library, or the like. It may be seen that the content contained in the screenshot may be very rich, and therefore, after taking the screenshot, the embodiment of the invention needs to conduct recognition on the screenshot of the slide area, and extract one or more object contained therein. Preferably, the extracted object may comprise at least one of: a text, a picture and a symbol. Multiple recognition techniques may be used, for example, the OCR (Optical Character Recognition) recognition technique, that is, text information is extracted from a picture by OCR recognition in the background; for another example, the UiAutomator automatic testing technique. The UiAutomator is an automatic testing tool that comes with android, and may be used for extracting text information of a current page, and such a technique may obtain 100% correct texts. There are different application scenarios for various recognition techniques, and a combination of the UiAutomator and the OCR can greatly improve the recognition accuracy.

To make stronger the visibility of the touch interaction based search method to a user, it may be possible to employ an operational means of presenting a translucent operable layer on the current interface after receiving a trigger instruction from the user for conducting touch search based on the current interface. The translucent operable layer overlays the current interface, and it can not only make the user see the interface clearly, but also a slide operation that is in conformity with the user's intention can be performed on the layer for the interface, such that the slide area determined by the slide operation accurately contain content that the user wants to search for. In an implementation, an effect similar to water mist glass erasure appears on the interface, and when a finger of the user slides over the touch screen, the water mist of the area that the finger slides over will be erased, and a text, an image such as a picture, etc. therein will be shown.

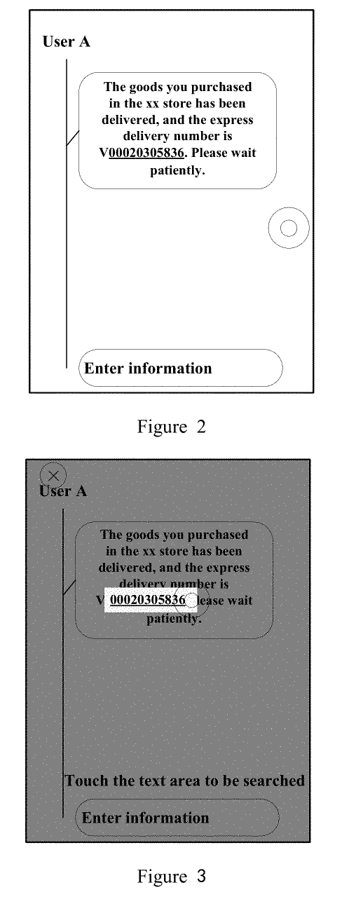

Therein, the operable layer may be implemented utilizing a trigger floating control. In an implementation, the floating control may be utilized to provide a search trigger entry in the current interface, and the user enters a trigger instruction via the search trigger entry, to trigger a subsequent flow. The shape of the search trigger entry may be a circle, a square, a polygon, etc. that can be clicked. To guarantee the normal application of the touch interaction interface, it is generally arranged at a side or corner position of the screen, and when triggered, it may invoke the translucent operable layer, in turn to finish the subsequent flow. FIG. 2 shows a schematic diagram of an SMS interface according to an embodiment of the invention. With reference to FIG. 2, the search trigger entry is arranged to be a double ring shape, and when it is clicked, the display of the translucent operable layer is triggered.

Now, text search is taken as an example to illustrate the touch interaction based search method provided by the embodiment of the invention. Since text search is implemented by a touch interaction mode, more vividly, it may be called touch word search. The embodiment is applied in a mobile terminal with a touch screen.

When the user clicks the touch word search trigger entry generated by the floating control when the screen is in any lit interface state, a layer of mask (i.e., the translucent operable layer mentioned above, which is referred to as a mask for short) is generated on the interface. The user may touch out a highlighted area by his finger's slide according to a position that he wants to select, and the text portion encompassed within the highlighted area is a text that the user wants to recognize and search for. The confirm button below is clicked, a screenshot of the highlighted area is popped up, the text in the screenshot is recognized based on this screenshot and inputted into the search box above, and the user clicks the search button, which may accomplish fast touch word search.

Therein, the embodiment recognizes a text in the screenshot according to a predetermined line-feed-touch-word recognition strategy, which is mainly applied in a mechanism in which a word that the user wants to touch out is located in two lines respectively. Touch word recognition works primarily based on a border (four points of the left, right, upper and lower (x, y)) of pixel points of a rectangle-like highlighted area generated on the mask by a user finger's slide. However, if a text belongs to two lines, and the finger slides twice, it will be still based on four pixel points, i.e., the left, right, upper and lower points, of a merged area for the two times, and the range circled out by such four pixel points is far larger than the highlighted area of the finger sliding twice, such that a highlighted word will not be targeted accurately. A solution is to consider the coincidence degree of the two line feed touch words, and if the coincidence degree is very low (for example, below 30%, wherein the threshold may be readjusted), treat them as two screenshots for recognition respectively, thus increasing the accuracy.

The flow of the embodiment may be summarized as: clicking the touch word search trigger entry->the system capturing the screen and the Uiautomator obtaining the current screen data->clipping picture analysis text data and transferring it to the background OCR for analysis->obtaining a result returned by the OCR->invoking a search engine for search. By the touch word search mode of the embodiment, a tedious soft keyboard input by the user may be omitted, and it is very convenient and fast.

In the embodiment, if the highlighted portion touched out by the user finger's slide is not accurate, and a situation occurs where the text cutting is not cut intact, then the border is extended by a certain threshold (e.g., 30%) based on the area where the user touches a word. As compared to the original screenshot, after the border extension, there is a new screenshot slightly larger than the original screenshot, and the new screenshot can contain a text which is cut half in the interface, which thus solves the problem that a text is not cut intact in an area where the user touches a word, and guarantees the integrity of searchable content acquisition.

### Embodiment One

The SMS interface shown in FIG. 2 is taken as a schematic diagram, wherein an express delivery number exists in the SMS content. For a user, what is cared about by him is the current state of the express, where it is, how long it will take to reach his own hands, what the express brother's contact information is, and the like. The information needs to be queried in the network according to the express delivery number.

In the embodiment, the user adds a translucent operable layer on the SMS interface by triggering the search trigger entry arranged to be a double ring shape, which operable layer is similar to frosted glass. FIG. 3 shows a schematic diagram of adding an operable layer on the interface of FIG. 2 according to an embodiment of the invention. Next, the user slides on the operable layer, the translucent effect is removed for an area which is slid over, and an object therein is shown clearly and recognized, which is referred to the number representative of the express delivery number in FIG. 3.

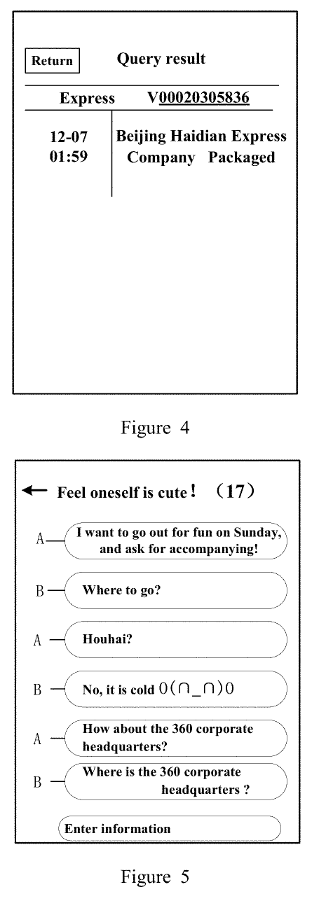

Then, search is conducted according to the express delivery number in FIG. 3 to obtain the query result as shown in FIG. 4.

It can be seen from this that by utilizing a finger's slide, the embodiment of the invention can select an express delivery number, conduct search for it and obtain a query result, which is simple and fast, and greatly enhances the user's experience.

### Embodiment Two

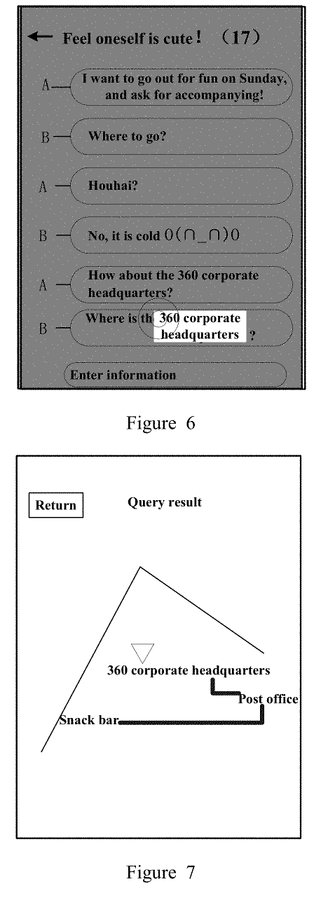

The embodiment is illustrated taking an instant message (IM) as an example. FIG. 5 shows a schematic diagram of an IM chat record according to an embodiment of the invention. Therein, a user A mentions a certain place, but a user B does not know it. At this point, the search trigger entry is triggered to add a translucent operable layer on the chat record. FIG. 6 shows a schematic diagram after adding an operable layer on the interface shown in FIG. 5. Next, the user slides on the “360 corporate headquarters” utilizing a finger, the translucent effect is removed, and the “360 corporate headquarters” is displayed clearly and recognized, which is referred to FIG. 6 for details.

Next, search is conducted for the recognized “360 corporate headquarters” to obtain its specific address. FIG. 7 shows a schematic diagram of the address of “360 corporate headquarters” according to an embodiment of the invention.

Thus, it can be seen that by utilizing a finger's slide, the embodiment of the invention can select a specified place and conduct search for it to obtain a query result, which is simple and fast, and greatly enhances the user's experience.

The embodiment is only illustrated taking a text as an example. In a practical application, the search mode for other objects such as a picture, a symbol, etc. is similar, which may be accomplished accordingly by the skilled in the art according to the above embodiment, and will not be repeated here.

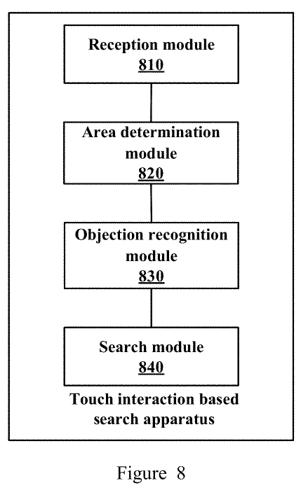

Based on one and the same inventive concept, an embodiment of the invention provides a touch interaction based search apparatus for supporting a touch interaction based search method provided by any of the above embodiments. FIG. 8 shows a structure diagram of a touch interaction based search apparatus according to an embodiment of the invention. With reference to FIG. 8, the apparatus comprises at least:

a reception module 810 configured to receive a trigger instruction from a user for conducting touch search based on a current interface;

the reception module 810 further configured to receive a touch slide operation performed by the user on the current interface;

an area determination module 820 coupled to the reception module 810 and configured to determine a slide area according to the slide operation;

an objection recognition module 830 coupled to the area determination module 820 and configured to, based on the slide area, extract an object therein; and

a search module 840 coupled to the objection recognition module 830 and configured to conduct search with respect to the extracted object.

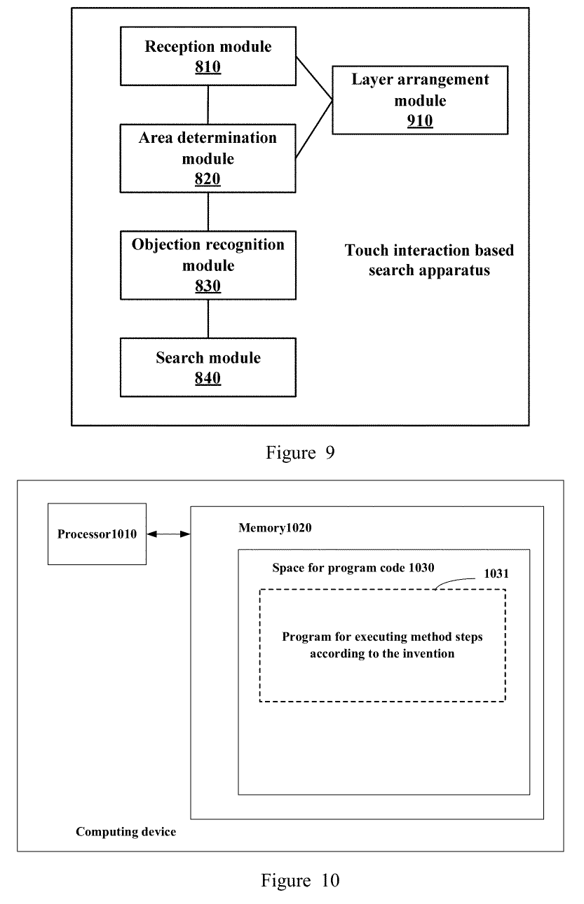

FIG. 9 shows another structure diagram of a touch interaction based search apparatus according to an embodiment of the invention. With reference to FIG. 9, in addition to the structure as shown in FIG. 8, the touch interaction based search apparatus further comprises:

a layer arrangement module 910 coupled to the reception module 810 and the area determination module 820, respectively, and configured to, after the receiving a trigger instruction from a user for conducting touch search based on a current interface, present a translucent operable layer on the current interface; and

the area determination module 820 further configured to perform a slide operation on the operable layer.

In a preferred embodiment, the operable layer is implemented utilizing a trigger floating control.

In a preferred embodiment, the reception module 810 may be further configured to receive a trigger instruction entered by the user via a search trigger entry provided by the floating control in the current interface.

In a preferred embodiment, the objection recognition module 890 is further configured to:

capture the slide area to obtain a corresponding screenshot of the slide area; and

conduct recognition on the screenshot of the slide area, and extract one or more object contained therein.

In a preferred embodiment, the object comprises at least one of: a text, a picture and a symbol.

Employment of the touch interaction based search method and apparatus provided by the embodiments of the invention can achieve the following beneficial effects:

In embodiments of the invention, a user sends out a trigger instruction for search based on a current interface; afterwards, a slide area is determined according to a touch slide operation performed by the user on the current interface; and then, based on the slide area, an object therein is extracted, and search is conducted with respect to the extracted object. From the above, the search of the embodiments of the invention does not need to open a search app, input an object in a search box, or copy & paste a selected object into a search box, and then conduct search. Rather, the embodiments of the invention define a slide area through a user's touch slide operation, directly extract an object in the slide area and search for it, which solves the problem of slow and inconvenient search due to inputting via a keyboard (including a soft keyboard), saves the above mentioned operations such as opening a search box, copy & paste, etc., makes the search operation simple and easy, solves the problem of search if one wants on a touch interaction based terminal, saves time and improves user's experience. In addition, the slide area can adequately reflect the user's search intention, which solves the drawback that a part of the existing search apps can only copy the whole content, but can not accurately search for a single word or several discrete words, and improves the accuracy of searching for a word.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a touch interaction based search device according to embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

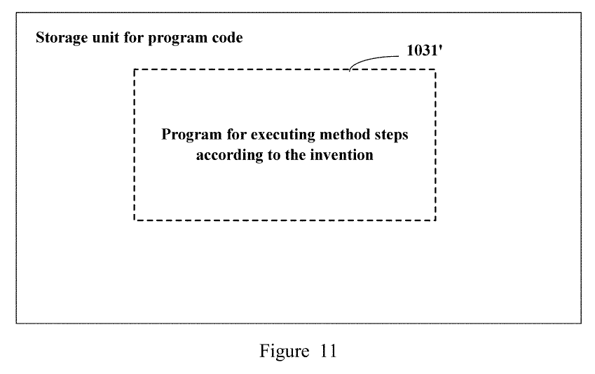

For example, FIG. 10 shows a computing device which may carry out a touch interaction based search method according to the invention. The computing device traditionally comprises a processor 1010 and a computer program product or a computer readable medium in the form of a memory 1020. The memory 1020 may be an electronic memory such as a flash memory, an EEPROM (electrically erasable programmable read-only memory), an EPROM, a hard disk or a ROM. The memory 1020 has a memory space 1030 for a program code 1031 for carrying out any method steps in the methods as described above. For example, the memory space 1030 for a program code may comprise individual program codes 1031 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 11. The storage unit may have a memory segment, a memory space, etc. arranged similarly to the memory 1020 in the computing device of FIG. 10. The program code may for example be compressed in an appropriate form. In general, the storage unit comprises a computer readable code 1031′, i.e., a code which may be read by e.g., a processor such as 1010, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A touch interaction based search method, comprising:
receiving a trigger instruction from a user for conducting search based on a current interface;
receiving a touch slide operation performed by the user on the current interface, and determining a slide area according to the touch slide operation; and
based on the slide area, extracting an object therein and conducting search with respect to the object.

2. The method as claimed in claim 1, wherein after the receiving a trigger instruction from a user for conducting touch search based on a current interface, the method further comprises: presenting a translucent operable layer on the current interface; and
wherein the touch slide operation performed on the current interface comprises:
performing a slide operation on the operable layer.

3. The method as claimed in claim 2, wherein the operable layer is implemented utilizing a trigger floating control.

4. The method as claimed in claim 3, wherein the receiving a trigger instruction from a user for conducting touch search based on a current interface comprises:
the floating control providing a search trigger entry in the current interface; and
receiving the trigger instruction entered by the user via the search trigger entry.

5. The method as claimed in claim 1, wherein based on the slide area, extracting an object therein, comprises:
capturing the slide area to obtain a corresponding screenshot of the slide area; and
conducting recognition on the screenshot of the slide area, and extracting one or more object contained therein.

6. The method as claimed in claim 1, wherein the object comprises at least one of: a text, a picture and a symbol.

7. A touch interaction based search apparatus, comprising:
a memory having instructions stored thereon;
a processor configured to execute the instructions to perform following operations:
receiving a trigger instruction from a user for conducting touch search based on a current interface;
receiving a touch slide operation performed by the user on the current interface;
determining a slide area according to the slide operation;
based on the slide area, extracting an object therein; and
conducting search with respect to the object.

8. The apparatus as claimed in claim 7,
wherein after the receiving a trigger instruction from a user for conducting touch search based on a current interface, the operations further comprise:
presenting a translucent operable layer on the current interface; and
wherein the touch slide operation performed on the current interface comprises:
performing a slide operation on the operable layer.

9. The apparatus as claimed in claim 8, wherein the operable layer is implemented utilizing a trigger floating control.

10. The apparatus as claimed in claim 9, wherein receiving a trigger instruction from a user for conducting touch search based on a current interface comprises:
the floating control providing a search trigger entry in the current interface; and
receiving the trigger instruction entered by the user via a search trigger entry.

11. The apparatus as claimed in claim 7, wherein based on the slide area, extracting an object therein, comprises:
capturing the slide area to obtain a corresponding screenshot of the slide area; and
conducting recognition on the screenshot of the slide area, and extracting one or more object contained therein.

12. The apparatus as claimed in claim 7, wherein the object comprises at least one of: a text, a picture and a symbol.

13. (canceled)

14. A non-transitory computer readable medium having instructions stored thereon that, when executed by at least one processor, cause the at least one processor to perform following operations:
receiving a trigger instruction from a user for conducting search based on a current interface;
receiving a touch slide operation performed by the user on the current interface, and determining a slide area according to the touch slide operation; and
based on the slide area, extracting an object therein and conducting search with respect to the object.
